(19) United States
(12) Patent Application Publication
(10) Pub. No.: US 2013/0191772 A1
(43) Pub. Date: Jul. 25, 2013

(54) METHOD AND APPARATUS FOR KEYBOARD LAYOUT USING TOUCH

(71) Applicant: Samsung Electronics Co., Ltd., Gyeonggi-do (KR)

(72) Inventor: Joo-Won HWANG, Seoul (KR)

(73) Assignee: SAMSUNG ELECTRONICS CO., LTD., Gyeonggi-do (KR)

(21) Appl. No.: 13/737,062

(22) Filed: Jan. 9, 2013

(30) Foreign Application Priority Data
Jan. 12, 2012 (KR) 10-2012-0003831

(51) Int. Cl. G06F 3/0481

(52) U.S. Cl. CPC G06F 3/04817
USPC 715/773

(57) ABSTRACT

A method includes selecting a desired keyboard layout by performing a specific touch input within or around a search window of a portable terminal whereby if a touch input is a first direction touch, a first keyboard layout with one language format is displayed, and a second keyboard layout with another language format is displayed if a second direction touch is detected.

### CLAIM OF PRIORITY

This application claims the benefit under 35 U.S.C. §119(a) of a Korean patent application filed in the Korean Intellectual Property Office on Jan. 12, 2012 and assigned Serial No. 10-2012-0003831, the entire disclosure of which is hereby incorporated by reference.

### BACKGROUND OF THE INVENTION

1. Field of the Invention

The present invention relates to a keyboard interface. More particularly, the present invention relates to a method and apparatus for changing a keyboard layout in a portable terminal.

2. Description of the Related Art

When a user inputs a search word to browse the Internet using a portable terminal, a default keyboard, for example, a Korean keyboard layout is displayed according to an initial setting (when it is set to Korean) in response to touching a search window. If the user desires to change the keyboard layout to English, the keyboard layout is typically changed by using a Korea/English shift key.

Thus, the user needs an additional touch manipulation to input a desired search word, which causes user inconvenience and is ineffective when the user requires a fast search.

### SUMMARY OF THE INVENTION

An aspect of the present invention is to solve at least the above-mentioned problems and/or disadvantages and also provide additional advantages, by providing a method and apparatus for selectively changing a keyboard layout according to a touch input.

Another aspect of the present invention is to provide a method and apparatus for pre-selecting a Korean keyboard layout or an English keyboard layout or a symbol keyboard layout or a number keyboard layout when a search is performed or before a user inputs a character, such as a message input.

Another aspect of the present invention is to provide a method and apparatus for selecting a keyboard layout of a desired language or symbol when a search is performed or before a user inputs a character by detecting a touch input on a search window of the portable terminal, and displaying the desired keyboard layout according to the detected outcome.

In accordance with an aspect of the present invention, a method of selecting a desired keyboard layout in a portable terminal includes: detecting a touch input on a search window of the portable terminal; if the touch input on the search window is a first direction slide, displaying a first keyboard layout; if the touch input on the search window is a second direction slide, displaying a second keyboard layout, and if the touch input on the search window is an N-th direction slide (wherein N is a natural number greater than 2), outputting a N-th keyboard layout, wherein if the touch input detected on the search window is a tap at one of a left portion, a center portion, and a right portion of the search window, displaying a particular keyboard layout according to detected tap location.

In accordance with another aspect of the present invention, a portable terminal apparatus for selecting a desired keyboard layout according to a touch input includes: a display and a controller for detecting type of the touch input occurs on a search window of the display and displaying the desired keyboard layout according to the detected outcome.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIGS. 1A and 1B illustrates a keyboard layout depending on first and second direction touches according to an exemplary embodiment of the present invention;

FIGS. 2A and 2B illustrates a keyboard layout depending on third and fourth direction touches according to an exemplary embodiment of the present invention;

FIGS. 3A and 3B illustrates a keyboard layout depending on first and second area touches according to an exemplary embodiment of the present invention;

FIG. 4 is a flowchart illustrating a process of configuring a keyboard layout depending on a direction touch according to an exemplary embodiment of the present invention;

FIG. 5 is a flowchart illustrating a process of changing a keyboard layout depending on a direction touch according to an exemplary embodiment of the present invention;

FIG. 6 is a flowchart illustrating a process of configuring a keyboard layout depending on an area touch according to an exemplary embodiment of the present invention;

FIG. 7 is a flowchart illustrating a process of changing a keyboard layout depending on an area touch according to an exemplary embodiment of the present invention; and

FIG. 8 is a block diagram illustrating a structure of a portable terminal according to an exemplary embodiment of the present invention.

### DETAILED DESCRIPTION OF EXEMPLARY EMBODIMENTS

The present invention relates to a method and apparatus for changing a keyboard layout having a particular language or symbol or number according to a user touch in a portable terminal.

Hereinafter, exemplary embodiments of the present invention will be described herein below with reference to the accompanying drawings. For the purposes of clarity and simplicity, well-known functions or constructions are not described in detail as they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

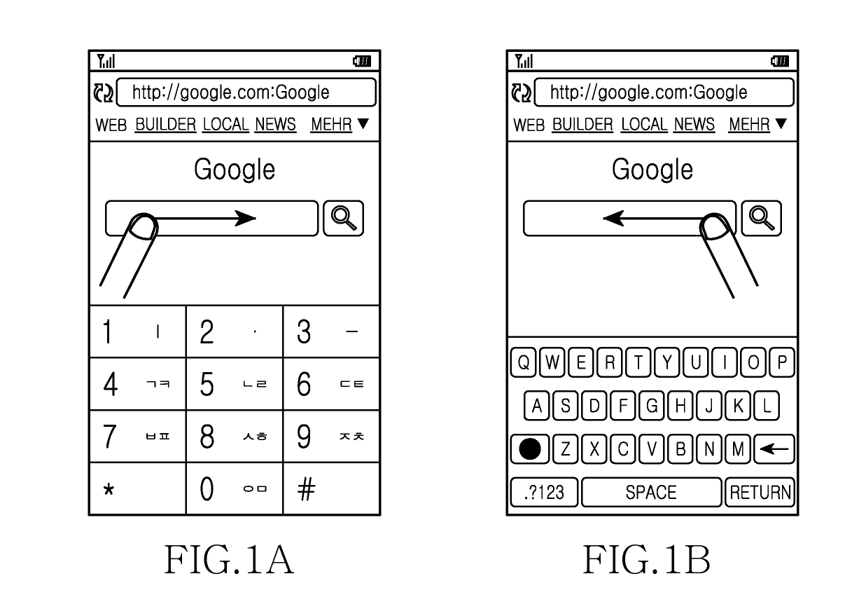

FIGS. 1A and 1B illustrates a keyboard layout depending on first and second direction touches according to an exemplary embodiment of the present invention.

FIG. 1A illustrates a Korean keyboard layout configured for a case of performing a left-to-right touch/slide or drag (hereinafter “a first direction touch”) according to the first embodiment of the present invention when a user who intends to perform a search operation by using a portable terminal touches a search window in a left-to-right direction.

FIG. 1B illustrates an English keyboard layout configured for a case of performing a right-to-left touch/slide or drag (hereinafter “a second direction touch”) according to the second embodiment of the present invention when a user who intends to perform a search operation by using a portable terminal touches a search window in a right-to-left direction.

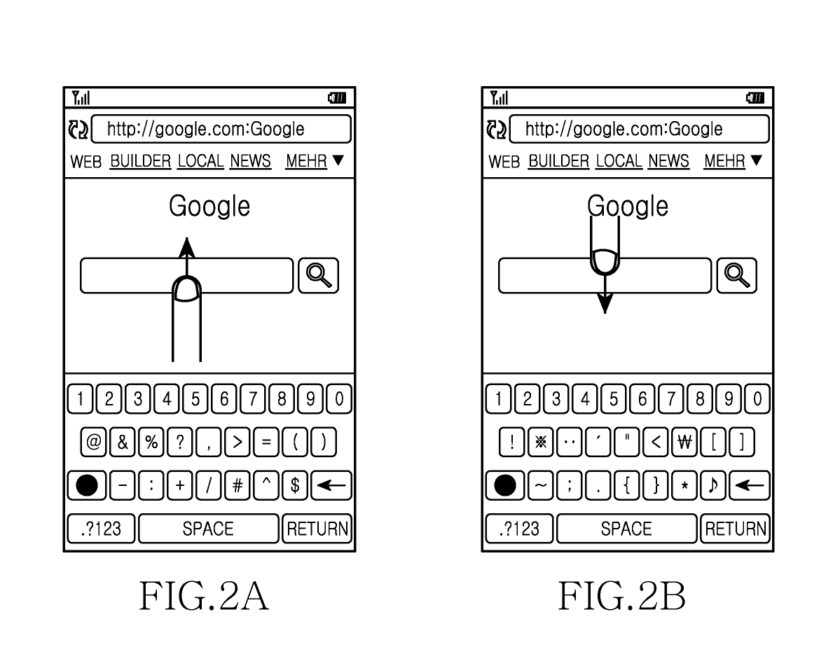

FIGS. 2A and 2B illustrates a keyboard layout depending on third and fourth direction touches according to an exemplary embodiment of the present invention.

FIG. 2A illustrates a first symbol keyboard layout configured for a case of performing a down-to-up touch/slide or drag (hereinafter “a third direction touch”) according to the third embodiment of the present invention when a user who intends to perform a search operation by using a portable terminal touches a search window in a down-to-up direction.

FIG. 2B illustrates a second symbol keyboard layout configured for a case of performing an up-to-down touch/slide or drag (hereinafter “a fourth direction touch”) according to the fourth embodiment of the present invention when a user who intends to perform a search operation by using a portable terminal touches a search window in an up-to-down direction.

It should be noted that different embodiments shown in FIGS. 1A and 1B and 2A and 2B are for illustrative purposes, thus other combination of sliding gesture detected on the search window can result in different type of keyboard layout. For example, the first direction touch or slide detected in FIG. 1a can generate another language keyboard other than Korean. Therefore, the illustrative embodiments in the figures should not limit the scope of the invention. Moreover, the teachings of the present invention are also applicable when an input touch or input slide is detected not only within the search window but also around or outside of the search window.

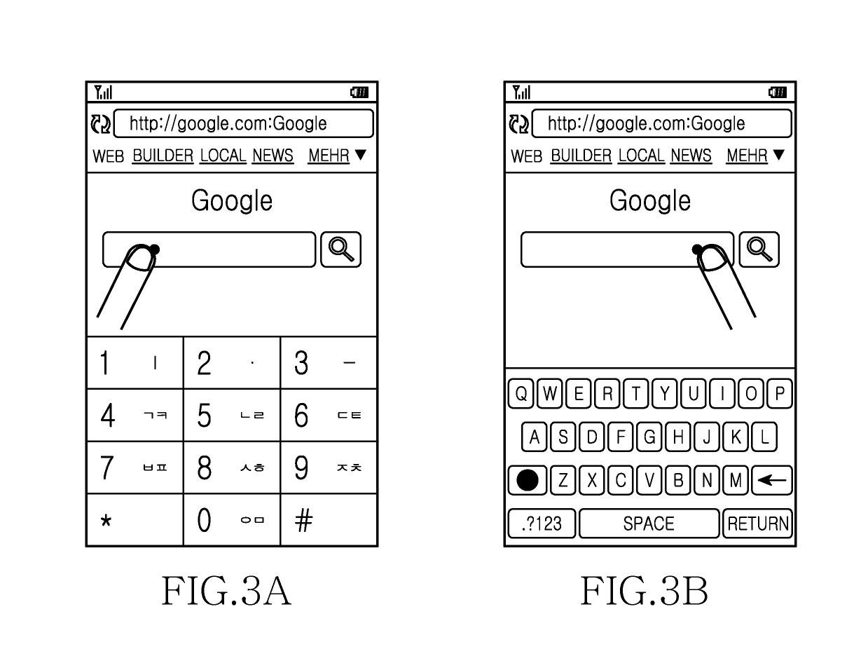

FIGS. 3A and 3B illustrates a keyboard layout depending on first and second area touches according to another exemplary embodiment of the present invention.

FIG. 3A illustrates a Korean keyboard layout configured for a case of touching a left area (or a first area touch) according to another embodiment of the present invention when a user who intends to perform a search operation by using a portable terminal touches or taps a left side from a center point of a search window.

FIG. 3B illustrates an English keyboard layout configured for a case of touching a right area or a second area touch according to yet another embodiment of the present invention when a user who intends to perform a search operation by using a portable terminal touches or taps a right side from a center point of a search window.

Again, it should be noted that different embodiments shown in FIGS. 3A and 3B are for illustrative purposes, and other language keyboard layout can be displayed according to the detected touch input within the search window. Thus, the illustrative embodiments in the figures should not limit the scope of the invention.

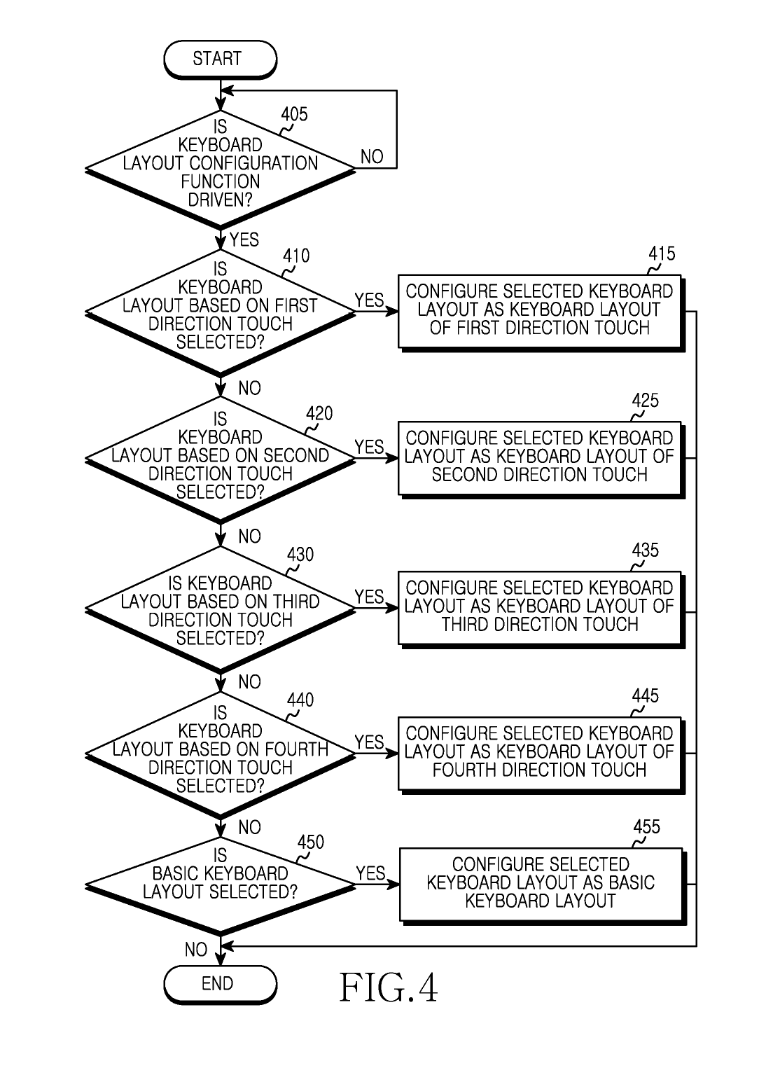

FIG. 4 is a flowchart illustrating a process of configuring a keyboard layout in a portable terminal according to a direction touch detected thereon in accordance with an exemplary embodiment of the present invention.

Referring to FIGS. 1A and 1B, 2A and 2B and 4, if a user drives a keyboard layout configuration function (step 405), a portable terminal examines whether the user selects a keyboard layout by performing a first direction touch detected within a search window (step 410). If the user performs the first direction touch, the portable terminal configures a particular keyboard layout to be used corresponding to the first direction touch (step 415).

If the user selects a keyboard layout by performing a second direction touch (step 420), the portable terminal configures a particular keyboard layout corresponding to the second direction touch (step 425).

If the user selects a keyboard layout by performing a third direction touch (step 430), the portable terminal configures a particular keyboard layout corresponding to the third direction touch (step 435).

If the user selects a keyboard layout by performing a fourth direction touch in the portable terminal (step 440), the portable terminal configures a particular keyboard layout corresponding to the fourth direction touch (step 445).

If the user simply touches the search window (step 450), the portable terminal configures a particular keyboard layout corresponding to the simple touch (step 455).

The method described above in relation with FIG. 4 under of the present invention may be provided as one or more instructions in one or more software modules stored in the respective apparatus.

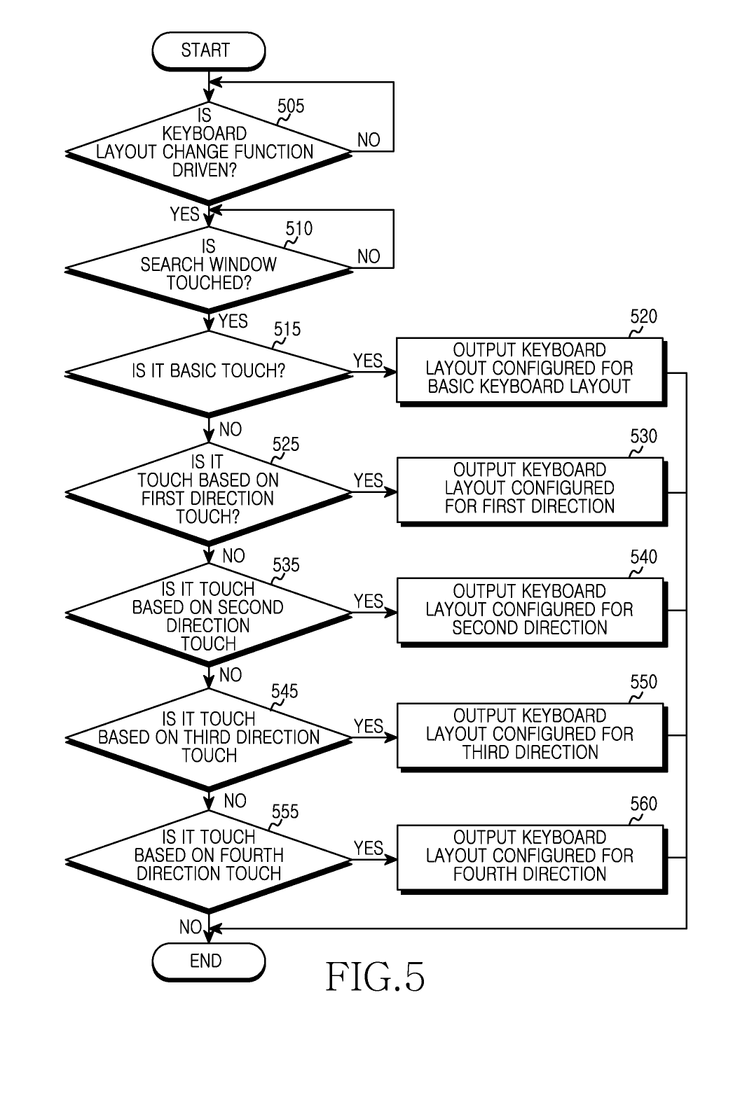

FIG. 5 is a flowchart illustrating a process of changing a keyboard layout depending on a direction touch according to an exemplary embodiment of the present invention.

Referring to FIGS. 1A and 1B, 2A and 2B and 5, if a user drives a keyboard layout change function (step 505, in this case, when the user touches a search window, a keyboard layout configured based on a touch direction or a touch area is output), the portable terminal examines whether the user manipulates the search window (step 510).

When the user touches or taps the search window (step 510), if the touch on the search window is a basic touch (step 515), herein the basic touch denotes the aforementioned simple touch), the portable terminal outputs a keyboard layout corresponding to a basic keyboard layout (step 520).

If the touch input detected on the search window is a first direction touch (step 525), the portable terminal outputs a keyboard layout corresponding to the first direction touch (step 530).

If the touch input detected on the search window is a second direction touch (step 535), the portable terminal outputs a keyboard layout corresponding to the second direction touch (step 540).

If the touch input detected on the search window is a third direction touch (step 545), the portable terminal outputs a keyboard layout corresponding to the third direction touch (step 550).

If the touch input on the search window is a fourth direction touch (step 555), the portable terminal outputs a keyboard layout corresponding to the fourth direction touch (step 560).

Although the touch inputs defined by the first to fourth directions are described in the present invention for illustrative purposes, the configuration and utilization for the directions are also applicable with any number of directions.

The method described above in relation with FIG. 5 under of the present invention may be provided as one or more instructions in one or more software modules stored in the respective apparatus.

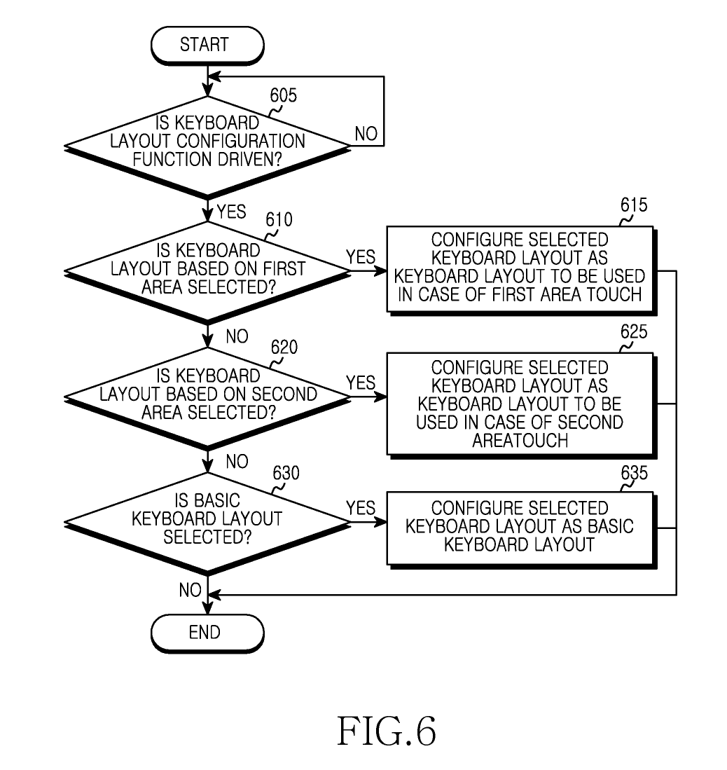

FIG. 6 is a flowchart illustrating a process of configuring a keyboard layout in a portable terminal depending on the location of a touch detected thereon according to an exemplary embodiment of the present invention.

Referring to FIGS. 3A, 3B and 6, if a user drives a keyboard layout configuration function (step 605), a portable terminal examines whether the user selects a keyboard layout based on a first area touch (step 610, such a process denotes a process of selecting a keyboard layout to be used when the user touches the first area of a search window). If the user selects the keyboard layout to be used in case of the first area touch, the portable terminal configures a particular keyboard layout corresponding to the first area touch (step 615).

In a case where the user selects a keyboard layout based on a second area touch in the portable terminal (step 620, such a case denotes a process of selecting the keyboard layout to be used when the user touches the second area of the search window), the portable terminal configures a particular keyboard layout corresponding to the second area touch (step 625).

If the user selects a basic keyboard layout in the portable terminal (step 630) by touching a center point of the search window, the portable terminal configures a basic keyboard layout (step 635).

The method described above in relation with FIG. 6 under of the present invention may be provided as one or more instructions in one or more software modules stored in the respective apparatus.

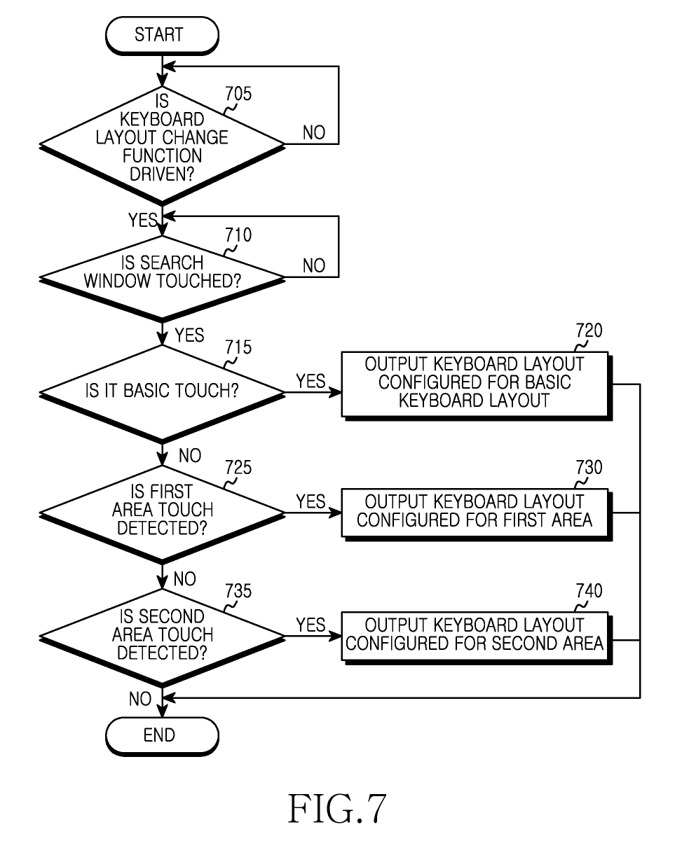

FIG. 7 is a flowchart illustrating a process of changing a keyboard layout depending on an area touch according to an exemplary embodiment of the present invention.

Referring to FIGS. 3A, 3B and 7, if a user drives a keyboard layout change function (step 705, in this case, when the user touches a search window, a keyboard layout configured based on a touch direction or a touch area is output), the portable terminal examines whether the user touches the search window (step 710).

When the user touches the search window (step 710), if the touch on the search window is a basic touch (step 715, herein, the basic touch denotes the aforementioned center touch of the search window), the portable terminal outputs a keyboard layout configured as the basic keyboard layout (step 720).

If the touch detected on the search window is a first area touch (step 725), the portable terminal outputs a keyboard layout corresponding to the first area touch (step 730).

If the touch detected on the search window is a second area touch (step 735), the portable terminal outputs a keyboard layout corresponding to the second area touch (step 740).

Although three different touch input locations described in the present invention for illustrative purposes, the configuration and utilization for the areas are also applicable to any number of touch input at different locations of the search window.

The method described above in relation with FIG. 7 under of the present invention may be provided as one or more instructions in one or more software modules stored in the respective apparatus.

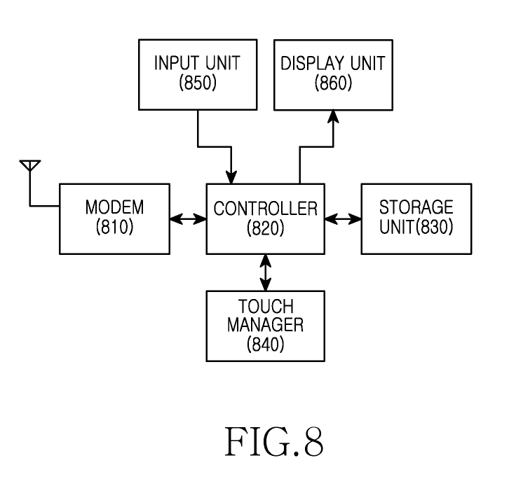

FIG. 8 is a block diagram illustrating a structure of a portable terminal according to an exemplary embodiment of the present invention.

Referring to FIG. 8, the portable terminal includes a modem 810, a controller 820, a storage unit 830, a touch manager 840, an input unit 850, and a display unit 860.

The modem 810 includes a radio processor, a baseband processor, etc. for communicating with other devices. The radio processor converts a signal received through an antenna into a baseband signal and provides the converted signal to the baseband processor. Further, the radio processor converts a baseband signal received from the baseband processor into a radio signal so that it can be transmitted on an actual air, and transmits the converted signal through the antenna.

The controller 820 provides an overall control to the portable terminal and may be integrated with the touch manager 840 as a single unit.

The storage unit 830 performs a function for storing a program controlling an overall operation of the portable terminal and a function for storing temporary data generated while performing the program.

The input unit 850 provides a touch input of the user to the controller 820 or the touch manager 840 and may be a touch screen.

The display unit 860 displays an output of the controller 840. The display unit 860 may be a Liquid Crystal Display (LCD), or Light Emitting Diode (LED) or other display devices known to those skilled in the art.

If a user drives a keyboard layout configuration function, the touch manager 840 examines whether the user selects a keyboard layout based on a first direction touch. Such a process denotes a process of selecting a keyboard layout to be used when the user touches a search window in the first direction. If the user selects the keyboard layout to be used in case of the first direction touch, the touch manager 840 configures the selected keyboard layout as the keyboard layout to be used in case of the first direction touch.

If the user selects a keyboard layout based on a second direction touch, the touch manager 840 configures the selected keyboard layout as a keyboard layout to be used in case of the second direction touch.

If the user selects a keyboard layout based on a third direction touch, the touch manger 840 configures the selected keyboard layout as the keyboard layout to be used in case of the third direction touch.

If the user selects a keyboard layout based on a fourth direction touch, the touch manager 840 configures the selected keyboard layout as the keyboard layout to be used in the fourth direction touch.

If the user selects a basic keyboard layout, the touch manager 840 configures the selected keyboard layout as the keyboard layout to be used in the simple touch.

If the user drives a keyboard layout change function (in this case, when the user touches a search window, a keyboard layout configured based on a touch direction or a touch area is output), the touch manager 840 examines whether the user touches the search window.

When the user touches the search window, if the touch on the search window is a basic touch (herein, the basic touch denotes the aforementioned simple touch), the touch manager 840 outputs a keyboard layout configured as the basic keyboard layout.

If the touch on the search window is a touch based on a first direction, the touch manager 840 outputs a keyboard layout configured for the first direction.

If the touch on the search window is a touch based on a second direction, the touch manager 840 outputs a keyboard layout configured for the second direction.

If the touch on the search window is a touch based on a third direction, the touch manager 840 outputs a keyboard layout configured for the third direction.

If the touch on the search window is a touch based on a fourth direction, the touch manager 840 outputs a keyboard layout configured for the fourth direction.

If the user drives a keyboard layout configuration function, the touch manager 840 examines whether the user selects a keyboard layout based on a first area touch (such a process denotes a process of selecting a keyboard layout to be used when the user touches the first area of the search window). If the user selects the keyboard layout to be used in case of the first area touch, the touch manager 840 configures the selected keyboard layout as the keyboard layout to be used in case of the first area touch.

If the user selects a keyboard layout based on a second area touch, the touch manager 840 configures the selected keyboard layout as the keyboard layout to be used in case of the second area touch.

If the user selects a basic keyboard layout, the touch manager 840 configures the selected keyboard as a basic keyboard layout.

If the user drives a keyboard layout change function, the touch manger 840 examines whether the user touches the search window.

When the user touches the search window, if the touch on the search window is a basic touch, the touch manager 840 outputs a keyboard layout configured as the basic keyboard layout.

If the touch on the search window is a touch based on a first area, the touch manager 840 outputs a keyboard layout configured for the first area.

If the touch on the search window is a touch based on a second area, the touch manager 840 outputs a keyboard layout configured for the second area.

The portable terminal may be an electronic device such as, for example, a laptop, a smart phone, a net book, a mobile internet device, an ultra mobile PC, a tablet personal computer, a mobile telecommunication terminal, PDA having a camera and the like herein, just to name some of the possibilities.

According to the teachings of the present invention, a user can selectively select a desired keyboard layout with a desired language or symbol by performing a specific touch input or touch, thereby providing convenience to the user and also facilitates an effective input environment for faster input.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of selecting a keyboard layout in a portable terminal, the method comprising:
detecting a touch input on a search window of the portable terminal;
if the touch input on the search window is a first direction slide, displaying a first keyboard layout; and
if the touch input on the search window is a second direction slide, displaying a second keyboard layout.

2. The method of claim 1, further comprising, if the touch input on the search window is an N-th direction slide, outputting a N-th keyboard layout.

3. The method of claim 1, wherein the touch input detected on the search window is a tap at one of a left portion, a center portion, and a right portion of the search window, displaying a particular keyboard layout according to detected tap location.

4. The method of claim 1, wherein the touch input is one of a drag, a slide and a tap.

5. The method of claim 1, further comprising: if the touch input on the search window is a third direction slide, displaying a third keyboard layout;
if the touch input on the search window is a fourth direction slide, displaying a fourth keyboard layout.

6. The method of claim 5, wherein the first direction slide comprises a left-to-right direction slide, the second direction slide comprises a right-to-left direction slide, a third direction slide comprises a down-to-up direction slide, and a fourth direction slide comprises an up-to-down direction slide.

7. The method of claim 5, wherein the third or fourth keyboard layout is one of a Korean keyboard layout, an English keyboard layout, a symbol keyboard layout, and a number keyboard layout.

8. The method of claim 1, wherein the first or second keyboard layout is one of a Korean keyboard layout, an English keyboard layout, a symbol keyboard layout, and a number keyboard layout.

9. A method of selecting a desired keyboard layout in a portable terminal, the method comprising:
detecting a touch input on a search window of the portable terminal; and
displaying the desired keyboard layout according to the detected outcome.

10. The method of claim 9, wherein if detected outcome is a tap at one of a left portion, a center portion, and a right portion of the search window, displaying a particular keyboard layout according to detected tap location.

11. The method of claim 9, wherein the touch input is one of a drag, a slide and a tap.

12. The method of claim 9, wherein the detected touch input is one of a left-to-right direction slide, a right-to-left direction slide, a down-to-up direction slide, and an up-to-down direction slide.

13. The method of claim 12, further comprising displaying the desired keyboard layout according to the detected direction slide.

14. The method of claim 9, wherein the desired keyboard layout is one of a Korean keyboard layout, an English keyboard layout, a symbol keyboard layout, and a number keyboard layout.

15. A portable terminal for selecting a desired keyboard layout according to a touch input, comprising:
a display; and
a controller for detecting type of the touch input occurs on a search window of the display and displaying the desired keyboard layout according to the detected outcome.

16. The portable terminal of claim 15, wherein if detected outcome is a tap at one of a left portion, a center portion, and a right portion of the search window, displaying a particular keyboard layout according to detected tap location.

17. The portable terminal of claim 15, wherein the touch input is one of a drag, a slide and a tap.

18. The portable terminal of claim 15, wherein the detected touch input is one of a left-to-right direction slide, a right-to-left direction slide, a down-to-up direction slide, and an up-to-down direction slide.

19. The portable terminal of claim 18, wherein the display displays the desired keyboard layout according to the detected direction slide.

20. The portable terminal of claim 15, wherein the desired keyboard layout is one of a Korean keyboard layout, an English keyboard layout, a symbol keyboard layout, and a number keyboard layout.
